(19) United States
(12) Patent Application Publication
(10) Pub. No.: US 2025/0229571 A1
(43) Pub. Date: Jul. 17, 2025

(54) DRIVEN AERODYNAMIC WHEEL COVER FLAP SYSTEM WITH OFFSET PASSIVE ACTUATOR

(71) Applicants: Hyundai Motor Company, Seoul (KR); Kia Corporation, Seoul (KR)

(72) Inventor: Timothy Harmon, Irvine, CA (US)

(21) Appl. No.: 18/415,076

(22) Filed: Jan. 17, 2024

(51) Int. Cl. B60B 7/04; B60B 7/00

(52) U.S. Cl. CPC B60B 7/04; B60B 7/008; B60B 2900/1216; B60B 2900/513; B60B 2900/572

(57) ABSTRACT

A wheel cover flap system and methods of use are provided. The wheel cover flap system may comprise a wheel, comprising one or more openings, and one or more wheel cover flaps, coupled to the wheel, configured to be positioned in an expanded position and a compressed position. In the expanded position, the one or more wheel cover flaps may be configured to cover the one or more openings of the wheel. In the compressed position, the one or more wheel cover flaps may be configured to uncover the one or more openings of the wheel. The wheel cover flap system may comprise dual offset actuators, configured to exert a collapsing force configured to compress the one or more wheel cover flaps and enable the one or more wheel cover flaps to expand when an expanding force exceeds the collapsing force.

### BACKGROUND

### Technical Field

Embodiments of the present disclosure relate to vehicle wheel cover flap systems and, in particular, to driven aerodynamic wheel cover flap systems with an offset passive actuator.

### Background

There are many different designs for vehicle wheels. These designs have various structural features and/or visual components, and are often designed based on visual preference. Most wheels come either in a standard “open” format, in an aerodynamic “semi-closed” format, or in a fully “closed” format.

Wheels with an open wheel design are highly desired by customers. An example prior art open wheel is shown in FIG. 1. However, while open wheels enable air flow for better brake cooling, they have poor aerodynamic performance.

Wheel covers are often used to close the open wheels and improve aerodynamic performance. An example prior art wheel cover is shown in FIG. 2. However, customers consider wheel covers presently on the market to have an unfavorable appearance and will often remove wheel covers after purchase for this reason. Additionally, due to their design, wheel covers often cause poor cooling performance for brakes.

In order to solve for the issue of poor cooling performance for brakes, wheel covers sometimes include shutters that are movable between open and closed positions. However, wheel covers that are movable between open and closed positions use a single actuator to cause the wheel cover to change between the open and closed positions, and this single actuator is prone to misalignment and jamming.

Closed and semi-closed wheels decrease the drag associated with open wheels. However, these wheels decrease air flow to the brakes, resulting in improper brake cooling.

The aerodynamic issues with wheel covers can cause serious issues for electric vehicle performance. Reducing the coefficient of drag on the wheel areas is critical for electric vehicles because a reduction in drag leads to more range, better battery efficiency, and better performance. Generally, at high speeds, reducing the open portion of the wheel leads to less drag on the wheel areas. However, at low speeds, the drag on the wheel areas is much less critical. During braking, the openings provide needed air flow for cooling.

Therefore, for at least these reasons and to solve these issues, driven aerodynamic wheel cover flaps with an offset passive actuator are needed, particularly for electric vehicles, that may be open when stationary, at low speeds, and when braking, and also closed when cruising at high speeds.

### SUMMARY

According to an object of the present disclosure, a wheel cover flap system is provided. The wheel cover flap system may comprise a wheel, comprising one or more openings, and one or more wheel cover flaps, coupled to the wheel, configured to be positioned in an expanded position and a compressed position. In the expanded position, the one or more wheel cover flaps may be configured to cover the one or more openings of the wheel. In the compressed position, the one or more wheel cover flaps may be configured to uncover the one or more openings of the wheel. The wheel cover flap system may comprise dual offset actuators, configured to exert a collapsing force configured to compress the one or more wheel cover flaps and enable the one or more wheel cover flaps to expand when an expanding force exceeds the collapsing force.

According to an exemplary embodiment, the dual offset actuators may comprise dual offset torsion springs.

According to an exemplary embodiment, the dual offset actuators may comprise dual helical tension springs.

According to an exemplary embodiment, the dual offset actuators may comprise a weight and spring system.

According to an exemplary embodiment, the collapsing force may comprise a spring compression force.

According to an exemplary embodiment, the one or more openings may comprise a plurality of openings and the one or more wheel cover flaps may comprise a plurality of wheel cover flaps.

According to an exemplary embodiment, a number of the plurality of openings may equal a number of the plurality of wheel cover flaps.

According to an exemplary embodiment, the one or more wheel cover flaps may comprise one or more telescopic wheel cover flaps.

According to an exemplary embodiment, the one or more wheel cover flaps may comprise one or more sliding wheel cover flaps.

According to an exemplary embodiment, the wheel cover flap system may comprise a track. The one or more sliding wheel cover flaps may be configured to slide along the track.

According to an exemplary embodiment, the wheel cover flap system may comprise a vehicle. The wheel may be mounted to the vehicle.

According to an exemplary embodiment, the vehicle may comprise an electric vehicle.

According to an object of the present disclosure, a method for operating a wheel cover flap system is provided. The method may comprise, when a vehicle, comprising a wheel cover flap system, is driving below a threshold speed, maintaining, using dual offset actuators, one or more wheel cover flaps in a compressed position. The wheel cover flap system may comprise a wheel, comprising one or more openings, and the one or more wheel cover flaps, coupled to the wheel, configured to be positioned in an expanded position and the compressed position. In the expanded position, the one or more wheel cover flaps may be configured to cover the one or more openings of the wheel. In the compressed position, the one or more wheel cover flaps may be configured to uncover the one or more openings of the wheel. The wheel cover flap system may comprise the dual offset actuators, configured to exert a collapsing force configured to compress the one or more wheel cover flaps and enable the one or more wheel cover flaps to expand when an expanding force exceeds the collapsing force. The method may comprise, when the vehicle is driving above the threshold speed, expanding the one or more wheel cover flaps to the expanded position, uncovering the one or more openings.

According to an exemplary embodiment, the method may comprise, when the vehicle is driving at the threshold speed, maintaining, using dual offset actuators, one or more wheel cover flaps in a compressed position.

According to an exemplary embodiment, the threshold speed may be 50 kmph.

According to an exemplary embodiment, the dual offset actuators may comprise dual offset torsion springs.

According to an exemplary embodiment, the dual offset actuators may comprise dual helical tension springs.

According to an exemplary embodiment, the dual offset actuators may comprise a weight and spring system.

According to an exemplary embodiment, the collapsing force may comprise a spring compression force.

According to an exemplary embodiment, the one or more openings may comprise a plurality of openings and the one or more wheel cover flaps may comprise a plurality of wheel cover flaps.

According to an exemplary embodiment, a number of the plurality of openings may equal a number of the plurality of wheel cover flaps.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a perspective view of a prior art open wheel.

FIG. 2 illustrates a perspective view of a prior art wheel cover on a vehicle wheel.

FIGS. 3A-3C illustrate a front view (FIG. 3A), a rear view (FIG. 3B) and a rear perspective view (FIG. 3C) of a wheel cover flap system in an open state, according to an exemplary embodiment of the present disclosure.

FIGS. 4A-4C illustrate a front view (FIG. 4A), a rear view (FIG. 4B) and a rear perspective view (FIG. 4C) of a wheel cover flap system in a semi-open or semi-closing state, according to an exemplary embodiment of the present disclosure.

FIGS. 5A-5C illustrate a front view (FIG. 4A), a rear view (FIG. 5B) and a rear perspective view (FIG. 5C) of a wheel cover flap system in a closed state, according to an exemplary embodiment of the present disclosure.

FIG. 6 illustrates a cover flap, of a wheel cover flap system, interchanging between an open state, a semi-open/semi-closed state, and a closed state, according to an exemplary embodiment of the present disclosure.

FIG. 7 illustrates a portion of a wheel cover flap system comprising a cover flap with a single fold, according to an exemplary embodiment of the present disclosure.

FIG. 8 illustrates a portion of a wheel cover flap system comprising a cover flap with a plurality of folds, according to an exemplary embodiment of the present disclosure.

FIG. 9 illustrates a portion of a wheel cover flap system comprising dual offset helical tension springs, according to an exemplary embodiment of the present disclosure.

FIG. 10 illustrates a portion of a wheel cover flap system comprising a telescoping cover flap, according to an exemplary embodiment of the present disclosure.

FIG. 11 illustrates a portion of a wheel cover flap system comprising a sliding cover flap, according to an exemplary embodiment of the present disclosure.

FIG. 12 illustrates a flowchart of a method for operating a wheel cover flap system, according to an exemplary embodiment of the present disclosure.

FIG. 13 illustrates example elements of a computing device, according to an exemplary embodiment of the present disclosure.

FIG. 14 illustrates an example architecture of a vehicle, according to an exemplary embodiment of the present disclosure.

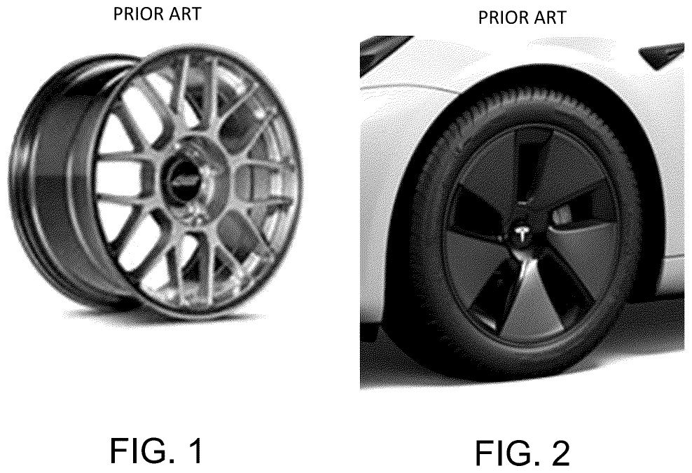

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments of the present disclosure, driven aerodynamic wheel cover flaps with an offset passive actuator are illustratively depicted.

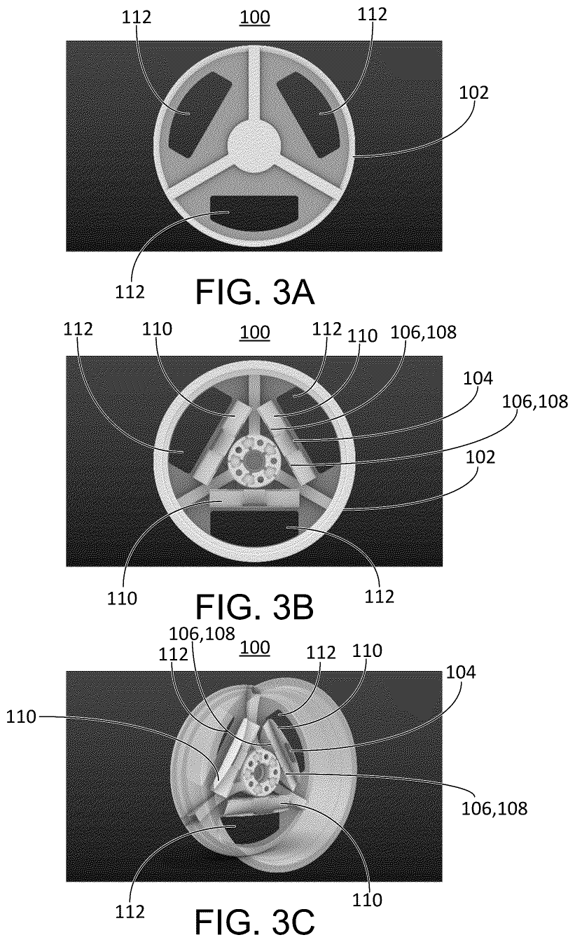

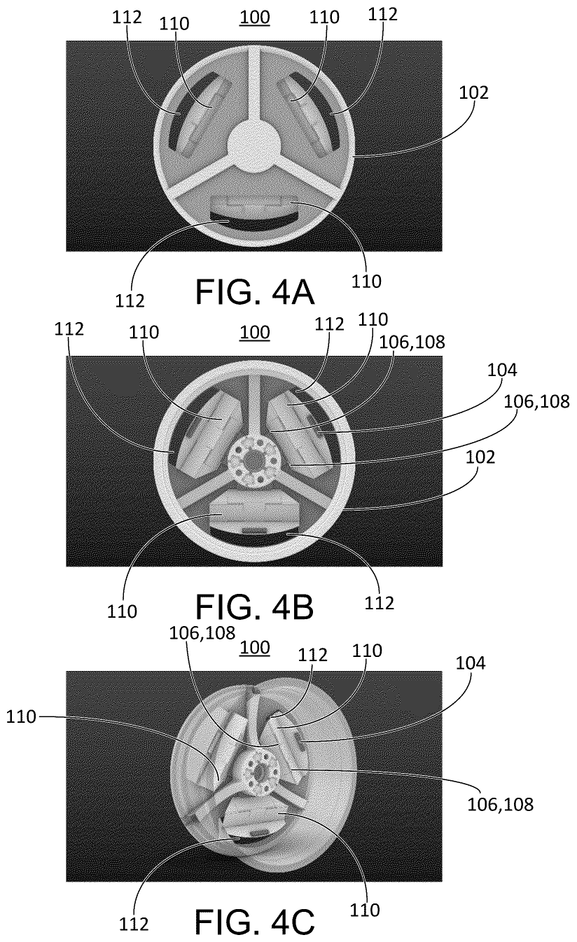

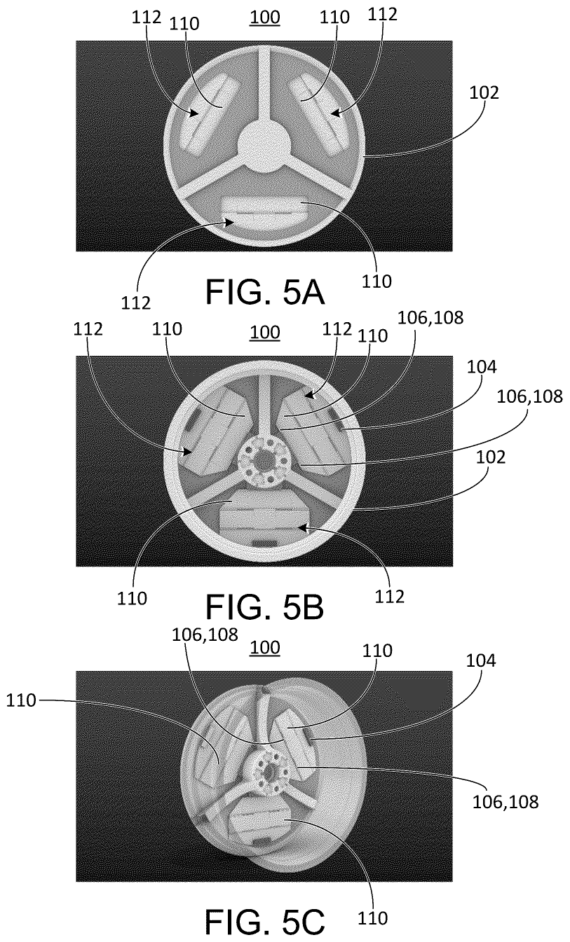

Referring now to FIGS. 3A-6C, a front view (FIG. 3A), a rear view (FIG. 3B) and a rear perspective view (FIG. 3C) of a wheel cover flap system 100 in an open state, a front view (FIG. 4A), a rear view (FIG. 4B) and a rear perspective view (FIG. 4C) of the wheel cover flap system 100 in a semi-open or semi-closing state, and a front view (FIG. 4A), a rear view (FIG. 5B) and a rear perspective view (FIG. 5C) of the wheel cover flap system 100 in a closed state are illustratively depicted, in accordance with exemplary embodiments of the present disclosure.

According to an exemplary embodiment, the wheel cover flap system 100 may comprise a vehicle wheel 102. The wheel cover flap system 100 may be aerodynamic in design and/or configured to achieve the benefits of standard “open” wheels and aerodynamic fully “closed” wheels. According to an exemplary embodiment, the wheel 102 may be mounted to a vehicle.

According to an exemplary embodiment, when a vehicle is stationary and/or at low speeds, the wheel cover flap system 100 may be configured to remain in an open state (as shown, e.g., in FIGS. 3A-3C). This open state allows for the favorable benefits of open wheels (e.g., the favorable appearance and, when braking, the air flow needed to adequately cool the brakes).

According to an exemplary embodiment, when the vehicle is at high speeds, the wheel cover flap 100 may be configured to close into a closed state (as shown, e.g., in FIGS. 5A-5C), reducing drag and leading to increased range, better battery efficiency, and better performance for electric vehicles.

According to an exemplary embodiment, the cover flap system 100 may be configured to be activated passively, using a weight 104 and spring 106 system, eliminating the need for any additional motors or electrical activation. According to an exemplary embodiment, the wheel flap 100 may comprise dual offset actuators 108. According to an exemplary embodiment, the weight 104 and spring 106 system may comprise a plurality of springs 106, functioning as the dual offset actuators 108. The dual offset actuators 108 aid in preventing jamming and misalignment.

According to an exemplary embodiment, the cover flap system 100 may be configured to transition from a plurality of states. For example, the cover flap system 100 may be configured to transition from an open state (as shown, e.g., in FIGS. 3A-3C), to a semi-closed state (as shown, e.g., in FIGS. 4A-4C), to a closed state (as shown, e.g., in FIGS. 5A-5C), to a semi-open state (as shown, e.g., in FIGS. 4A-4C), to an open state (as shown, e.g., in FIGS. 3A-3C).

The cover flap system 100 may comprise a plurality of wheel cover flaps 110. According to an exemplary embodiment, each of the cover flaps 110 may be configured to block, wholly and/or partially, one or more openings 112 in the wheel 102. According to an exemplary embodiment, the number of openings 112 in the wheel 102 equals the number of cover flaps 110 in the wheel cover flap system 100.

According to an exemplary embodiment, in the open state (as shown, e.g., in FIGS. 3A-3C), the plurality of cover flaps 110 are in a resting or compressed position, uncovering the openings 112 in the wheel 102. According to an exemplary embodiment, when the wheel cover flap system 100 is in the open state, the cover flaps 110 are not visible from a front view (as shown, e.g., in FIG. 3A) and therefore do not cover the openings 112 in the wheel 102.

According to an exemplary embodiment, when the vehicle is stationary or moving at low speeds (e.g., speeds of less than 50 kmph), the wheel cover flap system 100 is configured such that the cover flaps 110 remain in the resting/compressed position. According to an exemplary embodiment, the weight 104 and spring 106 system comprises a plurality of offset torsion springs 106 configured to hold the cover flaps 110 in the resting/compressed position.

According to an exemplary embodiment, the springs 106 are configured to have a compressive spring force configured to hold the cover flaps 110 in the compressed position. The compressive spring force is configured to act as a collapsing force configured to cause the cover flaps 110 to collapse into the compressed position. As the wheel spins, a centrifugal force is applied to the cover flaps 110, caused by the spinning of the wheel 102. The centrifugal force is configured to act as an expanding force configured to offset the force exerted by the collapsing force of the springs 106.

When the centrifugal force is less than or equal to the compressive spring force (e.g., when the vehicle is driving less than 50 kmph), the springs 106 are configured to hold the cover flaps 110 in the compressed position. When the centrifugal force is greater than the compressive spring force (e.g., when the vehicle is traveling at greater than 50 kmph), the cover flaps 110 may move into the semi-open state (as shown, e.g., in FIGS. 4A-4C) and/or the closed state (as shown, e.g., in FIGS. 5A-5C).

According to an exemplary embodiment, when the wheel cover flap system 100 is in the semi-open/semi-closed state (as shown, e.g., in FIGS. 4A-4C), the cover flaps 110 are in the process of closing (e.g., when the centrifugal force exceeds the compressive spring force), covering or “closing” the openings 112 in the wheel 102, or the cover flaps 110 are in the process of opening (e.g., when the centrifugal force is less than or equal to the compressive spring force), uncovering or “opening” the openings 112 in the wheel 102.

According to an exemplary embodiment, when the centrifugal force exceeds the compressive spring force and the vehicle continues to increase speed, the cover flap system 100 is configured such that the excess centrifugal force causes the cover flaps 110 to fully cover the openings 112 in the wheel 102, causing the cover flap system 100 to be in, and remain in, the closed state (as shown, e.g., in FIGS. 5A-5C). When the centrifugal force decreases to less than or equal to the compressive spring force (e.g., when the vehicle slows down to 50 kmph or less), the cover flap system 100 may be configured to revert back into the semi-open/semi-closed state (as shown, e.g., in FIGS. 4A-4B) and/or the closed state (as shown, e.g., in FIGS. 3A-3B).

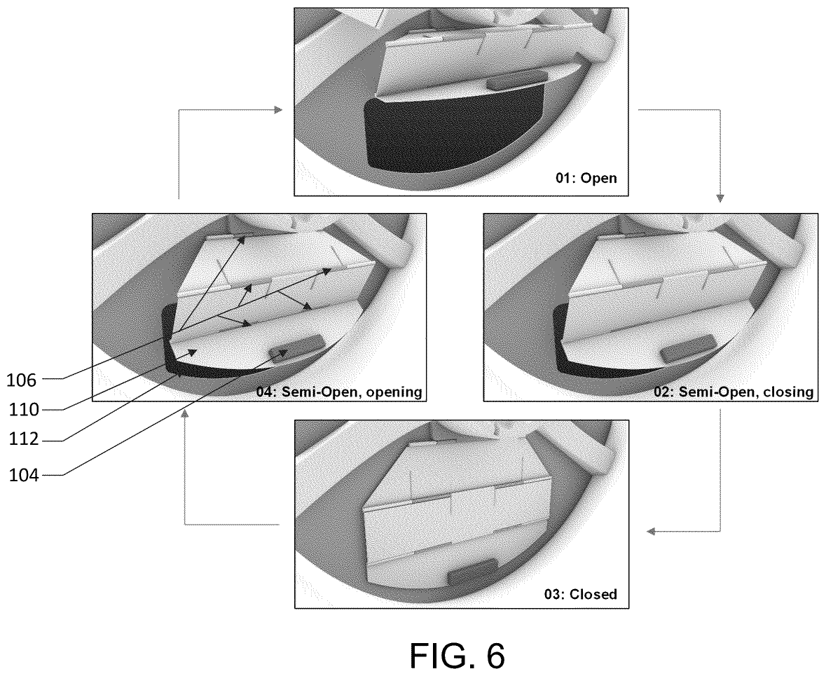

The process of the cover flaps 110 interchanging between the open state, the semi-open/semi-closed state, and the closed state is shown, e.g., in FIG. 6.

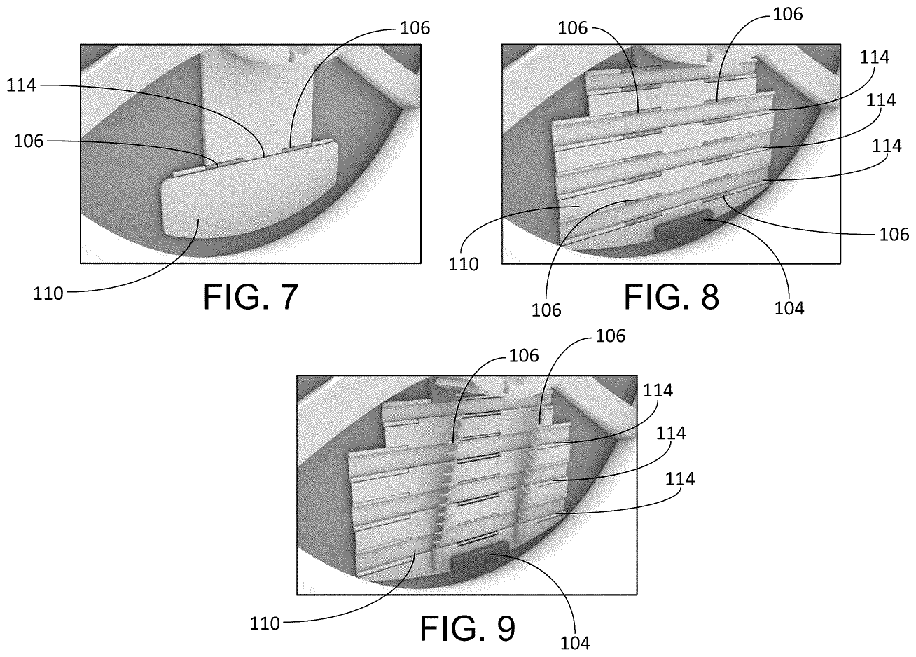

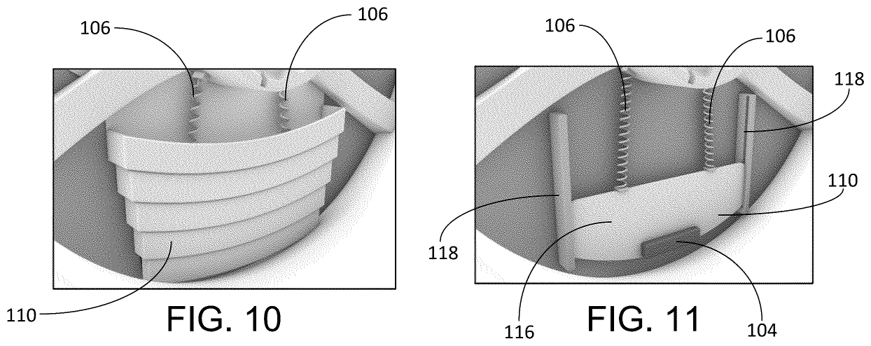

The cover flaps 110 may comprise one or more configurations for expanding and/or contracting. For example, according to an exemplary embodiment, the cover flaps 110 may comprise a single fold 114 (as shown, e.g., in FIG. 7) and/or a plurality of folds 114 (as shown, e.g., in FIG. 8). According to an exemplary embodiment, the spring 106 or springs 106 may comprise dual offset helical tension springs 106 (as shown, e.g., in FIGS. 9-10) and/or other suitable spring components. According to an exemplary embodiment, the cover flaps 110 may be configured to telescope open and/or closed (as shown, e.g., in FIG. 11) and/or may comprise a sliding component 116 (e.g., a sliding wheel cover flap 110) configured to slide on, e.g., a track 118 (as shown, e.g., in FIG. 11).

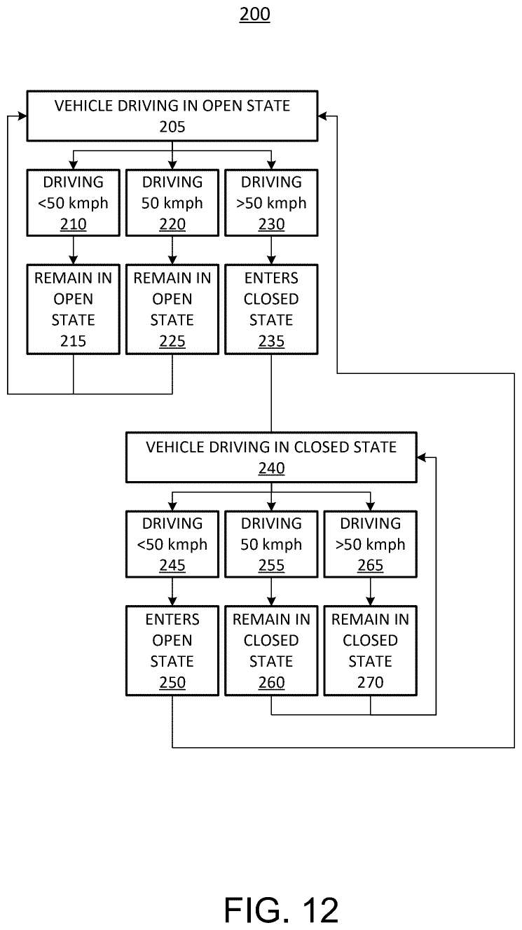

Referring now to FIG. 12, a flowchart of a method 200 for operating a wheel cover flap system is illustratively depicted, in accordance with an exemplary embodiment of the present disclosure.

At 205, a vehicle drives with the cover flap system in the open state with the cover flaps in a compressed state, uncovering openings in the wheel.

When the vehicle, at 210, is driving at a low driving speed below a threshold speed (e.g., a speed less than 50 kmph), then, at 215, the compression spring force overcomes the centrifugal force, causing the cover flaps to remain compressed and the wheel cover flap system to maintain the open state, enabling the vehicle, at 205, to drive with the cover flap system in the open state.

When the vehicle, at 220, is driving at a medium driving speed at the threshold speed (e.g., a speed of 50 kmph), then, at 225, the compression spring form and the centrifugal force are equal, causing the cover flaps to remain compressed and the wheel cover flap system to maintain the open state, enabling the vehicle, at 205, to drive with the cover flap system in the open state.

When the vehicle, at 230, is driving at a high driving speed above the threshold speed (e.g., a speed greater than 50 kmph), then, at 235, the centrifugal force overcomes the compression spring force, causing the cover flaps to expand and cover the openings in the wheel, causing the cover flap system to enter a closed state, enabling the vehicle, at 240, to drive with the cover flap system in the closed state.

When the vehicle, at 245, is driving at a low driving speed (e.g., a speed less than 50 kmph), then, at 250, the compression spring force overcomes the centrifugal force, causing the cover flaps to compress and the wheel cover flap system to enter the open state, enabling the vehicle, at 205, to drive with the cover flap system in the open state.

When the vehicle, at 255, is driving at a medium driving speed (e.g., a speed of 50 kmph), then, at 260, the compression spring form and the centrifugal force are equal, causing the cover flaps to remain uncompressed and the wheel cover flap system to maintain the closed state, enabling the vehicle, at 240, to drive with the cover flap system in the closed state.

When the vehicle, at 265, is driving at a high driving speed (e.g., a speed greater than 50 kmph), then, at 270, the centrifugal force overcomes the compression spring force, causing the cover flaps to maintain their expanded positions, causing the cover flap system to maintain the closed state, enabling the vehicle, at 240, to drive with the cover flap system in the closed state.

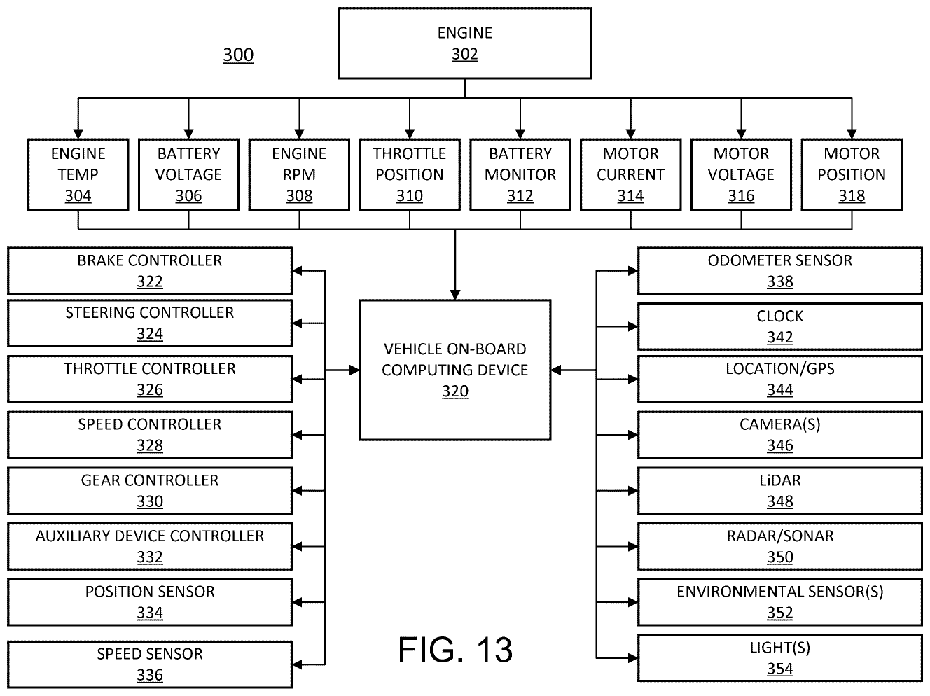

Referring now to FIG. 13, an example vehicle system architecture 300 for a vehicle is provided, in accordance with an exemplary embodiment of the present disclosure. The following discussion of vehicle system architecture 300 is sufficient for understanding one or more components of a vehicle onto which the wheel 102 of the wheel cover flap system 100 may be mounted.

According to an exemplary embodiment, the wheel cover flap system 100 may be a component of a vehicle (e.g., an electric vehicle) having vehicle architecture 300. As shown in FIG. 13, the vehicle system architecture 300 may comprise an engine, motor or propulsive device 302 and various sensors 304-318 for measuring various parameters of the vehicle system architecture 300. In gas-powered or hybrid vehicles having a fuel-powered engine, the sensors 304-318 may comprise, for example, an engine temperature sensor 304, a battery voltage sensor 306, an engine Rotations Per Minute (RPM) sensor 308, and/or a throttle position sensor 310. If the vehicle is an electric or hybrid vehicle, then the vehicle may comprise an electric motor, and accordingly may comprise sensors such as a battery monitoring system 312 (to measure current, voltage and/or temperature of the battery), motor current 314 and voltage 316 sensors, and motor position sensors such as resolvers and encoders 318.

Operational parameter sensors that are common to both types of vehicles may comprise, for example: a position sensor 334 such as an accelerometer, gyroscope and/or inertial measurement unit; a speed sensor 336; and/or an odometer sensor 338. The vehicle system architecture 300 also may comprise a clock 342 that the system uses to determine vehicle time and/or date during operation. The clock 342 may be encoded into the vehicle on-board computing device 320, it may be a separate device, or multiple clocks may be available.

The vehicle system architecture 300 also may comprise various sensors that operate to gather information about the environment in which the vehicle is traveling. These sensors may comprise, for example: a location sensor 344 (for example, a Global Positioning System (GPS) device); object detection sensors such as one or more cameras 346; a LiDAR sensor system 348; and/or a RADAR and/or a sonar system 350. The sensors also may comprise environmental sensors 352 such as, e.g., a humidity sensor, a precipitation sensor, a light sensor, and/or ambient temperature sensor. The object detection sensors may be configured to enable the vehicle system architecture 300 to detect objects that are within a given distance range of the vehicle in any direction, while the environmental sensors 352 may be configured to collect data about environmental conditions within the vehicle's area of travel. According to an exemplary embodiment, the vehicle system architecture 300 may comprise one or more lights 354 (e.g., headlights, flood lights, flashlights, etc.).

During operations, information may be communicated from the sensors to an on-board computing device 320 (e.g., computing device 400). The on-board computing device 320 may be configured to analyze the data captured by the sensors and/or data received from data providers and may be configured to optionally control operations of the vehicle system architecture 300 based on results of the analysis. For example, the on-board computing device 320 may be configured to control: braking via a brake controller 322; direction via a steering controller 324; speed and acceleration via a throttle controller 326 (in a gas-powered vehicle) or a motor speed controller 328 (such as a current level controller in an electric vehicle); a differential gear controller 330 (in vehicles with transmissions); and/or other controllers. The brake controller 322 may comprise a pedal effort sensor, pedal effort sensor, and/or simulator temperature sensor, as described herein.

Geographic location information may be communicated from the location sensor 344 to the on-board computing device 320, which may then access a map of the environment that corresponds to the location information to determine known fixed features of the environment such as streets, buildings, stop signs and/or stop/go signals. Captured images from the cameras 346 and/or object detection information captured from sensors such as LiDAR 348 may be communicated from those sensors to the on-board computing device 320. The object detection information and/or captured images may be processed by the on-board computing device 320 to detect objects in proximity to the vehicle. Any known or to be known technique for making an object detection based on sensor data and/or captured images may be used in the embodiments disclosed in this document.

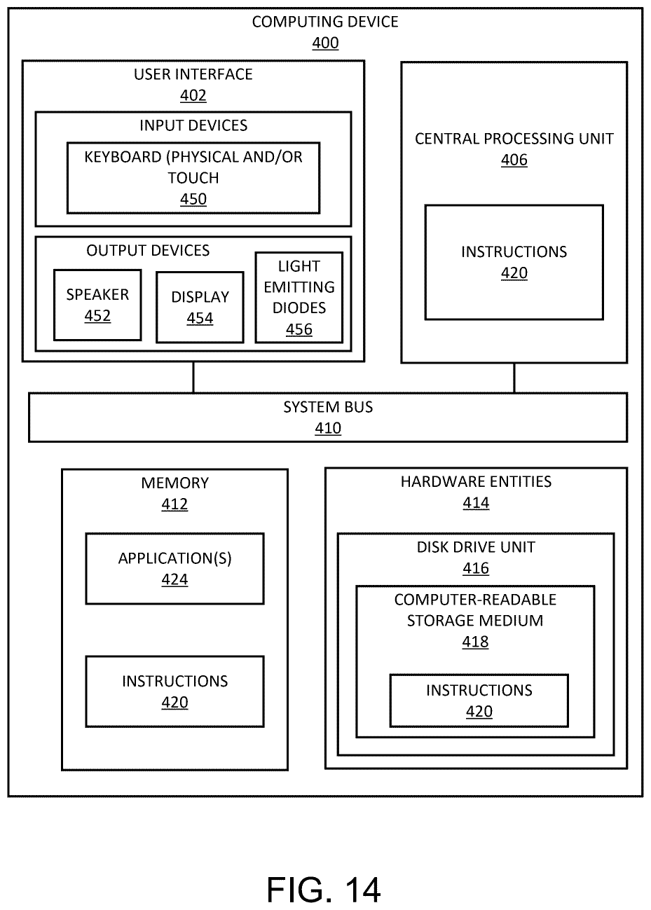

Referring now to FIG. 14, an illustration of an example architecture for a computing device 400 is provided. According to an exemplary embodiment, one or more functions of the present disclosure may be implemented by a computing device such as, e.g., computing device 400 or a computing device similar to computing device 400. Computing device 400 may be a quantum computer, a classical computer, and/or have one or more components configured to perform one or more quantum and/or classical computing functions.

The hardware architecture of FIG. 14 represents one example implementation of a representative computing device configured to implement at least a portion of the method(s) described herein.

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 4, the computing device 400 may comprise a user interface 402 (e.g., a graphical user interface), a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 440. The input devices may be connected to the computing device 400 via a wired or wireless connection (e.g., a Bluetooth® connection). The output devices may comprise, but are not limited to, a speaker 442, a display 444, and/or light emitting diodes 446.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding, or carrying a set of instructions 420 for execution by the computing device 400 and that cause the computing device 400 to perform any one or more of the methodologies of the present disclosure.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A wheel cover flap system, comprising:
a wheel, comprising one or more openings;
one or more wheel cover flaps, coupled to the wheel, configured to be positioned in an expanded position and a compressed position, wherein:
in the expanded position, the one or more wheel cover flaps are configured to cover the one or more openings of the wheel, and
in the compressed position, the one or more wheel cover flaps are configured to uncover the one or more openings of the wheel; and
dual offset actuators, configured to:
exert a collapsing force configured to compress the one or more wheel cover flaps; and
enable the one or more wheel cover flaps to expand when an expanding force exceeds the collapsing force.

2. The wheel cover flap system of claim 1, wherein the dual offset actuators comprise dual offset torsion springs.

3. The wheel cover flap system of claim 1, wherein the dual offset actuators comprise dual helical tension springs.

4. The wheel cover flap system of claim 1, wherein the dual offset actuators comprise a weight and spring system.

5. The wheel cover flap system of claim 5, wherein the collapsing force is a spring compression force.

6. The wheel cover flap system of claim 1, wherein the one or more openings comprises a plurality of openings and the one or more wheel cover flaps comprises a plurality of wheel cover flaps.

7. The wheel cover flap system of claim 6, wherein a number of the plurality of openings equals a number of the plurality of wheel cover flaps.

8. The wheel cover flap system of claim 1, wherein the one or more wheel cover flaps comprise one or more telescopic wheel cover flaps.

9. The wheel cover flap system of claim 1, wherein the one or more wheel cover flaps comprise one or more sliding wheel cover flaps.

10. The wheel cover flap system of claim 9, further comprising a track,
wherein the one or more sliding wheel cover flaps are configured to slide along the track.

11. The wheel cover flap system of claim 1, further comprising a vehicle,
wherein the wheel is mounted to the vehicle.

12. The wheel cover flap system of claim 11, wherein the vehicle comprises an electric vehicle.

13. A method for operating a wheel cover flap system, comprising:
when a vehicle, comprising a wheel cover flap system, is driving below a threshold speed, maintaining, using dual offset actuators, one or more wheel cover flaps in a compressed position, wherein the wheel cover flap system comprises:
a wheel, comprising one or more openings;
the one or more wheel cover flaps, coupled to the wheel, configured to be positioned in an expanded position and the compressed position, wherein:
in the expanded position, the one or more wheel cover flaps are configured to cover the one or more openings of the wheel, and
in the compressed position, the one or more wheel cover flaps are configured to uncover the one or more openings of the wheel; and
the dual offset actuators, configured to:
exert a collapsing force configured to compress the one or more wheel cover flaps; and
enable the one or more wheel cover flaps to expand when an expanding force exceeds the collapsing force; and
when the vehicle is driving above the threshold speed, expanding the one or more wheel cover flaps to the expanded position, uncovering the one or more openings.

14. The method of claim 13, further comprising, when the vehicle is driving at the threshold speed, maintaining, using dual offset actuators, one or more wheel cover flaps in a compressed position.

15. The method of claim 13, wherein the threshold speed is 50 kmph.

16. The method of claim 13, wherein the dual offset actuators comprise dual offset torsion springs.

17. The method of claim 13, wherein the dual offset actuators comprise dual helical tension springs.

18. The method of claim 13, wherein the dual offset actuators comprise a weight and spring system.

19. The method of claim 18, wherein the collapsing force is a spring compression force.

20. The method of claim 13, wherein:
the one or more openings comprises a plurality of openings and the one or more wheel cover flaps comprises a plurality of wheel cover flaps, and
a number of the plurality of openings equals a number of the plurality of wheel cover flaps.
